(19) United States
(12) Patent Application Publication
(10) Pub. No.: US 2006/0261026 A1
(43) Pub. Date: Nov. 23, 2006

(54) Nursing bottle air-inlet regulating valve

(76) Inventor: Ramiro Pillado, Buenos Aires (AR)

Correspondence Address: AKERMAN SENTERFITT, P.O. BOX 3188, WEST PALM BEACH, FL, 33402-3188, US

(21) Appl. No.: 11/356,609

(22) Filed: Feb. 17, 2006

(30) Foreign Application Priority Data
Feb. 18, 2005 (AR) P20050100602

(51) Int. Cl. A61J 9/00

(52) U.S. Cl. 215/11.4

(57) ABSTRACT

Nursing bottle air-inlet regulating valve comprising a flat elastomeric valve (1) that lies on the inner part of the threaded base (2) of the nursing bottle body (3) and comprises small domes (4) on the upper side (where the liquid is). Said domes (4) have a slit (5) at the end, through which the air flows to balance the pressure in the nursing bottle. Furthermore, comprises vent channels (6) on the underside (facing the domes, where there is no liquid), which is the side the membrane contacts the threaded base (2) of the nursing bottle. The circular membrane (1) comprises a perimeter wall or edge (9) that fits in the inner perimeter of the threaded base (2), continuing in a hollow perimeter channel (7) allowing air to circulate when the base (2) is unthreaded. The domes (4) are connected to the perimeter channel (7) by small bridges (8) that complete the air-inlet flow, which will be regulated by how much the vent channels (6) are squashed, which are also connected to the hollow perimeter channel (7). These vent channels (6) allow the air to flow from outside the nursing bottle towards the domes, through the communicating channels that open to the outside when partially unthreading the threaded base (2) of the nursing bottle, said base (2) having a series of openings through which atmospheric air flows.

### BRIEF DESCRIPTION OF THE INVENTION

The present invention refers to nursing bottles, more specifically to nursing bottles having air-inlet regulating devices comprising a valve configures to such effect.

The proposed valve allows to regulate as applicable air inside the nursing bottle, avoiding vacuum when the baby is suctioning the nipple causing an unbalanced air pressure in the nursing bottle body. As air is allowed into the body, the pressure is no longer unbalanced therein and the outlet flow of liquid is increased, in this manner it is possible to regulate the liquid flow that the baby is drinking.

### PRIOR ART

Traditional nursing and baby bottles only have one discharge outlet for the liquid at the end of the nipple and do not provide for any air inlet. The problem posed by these nursing bottles amply disclosed in prior art are well known: as the baby suctions an unbalance in the pressure in the body of the nursing bottle is produced, causing the liquid to flow unsteadily and the infant swallows a lot more liquid leading to indigestion.

Taking this problem into account, prior art developed by providing nursing bottles having valves allowing air inlet from the threaded base of the nursing bottles body.

Some of these valves are disclosed in U.S. Pat. Nos. 5,339,971, 5,499,729 and 5,431,290.

Most of these nursing bottles provide valves for air-inlet that generally comprise nipples with openings or slits coinciding with air-inlet openings provided on the threaded base of the nursing bottle, such that when the infant suctions the liquid through the nipple, an unbalance of pressure is generated in the bottle and the openings or slits in the nipple allow air in to avoid vacuum forming. When the nursing bottle is at rest, the pressure of the liquid inside the nipple causes the slits to close and stops the liquid from flowing out.

Notwithstanding, the new problem to overcome stated in these configurations is although the liquid does not flow unsteadily but continuously, outflow of liquid is sometimes too important as regards the adequate amount the infant can drink, especially in newly born ones.

The excessive liquid flow would cause chocking or that the infant drink the liquid too fast and suffer indigestion, with the implied inconvenience.

The present application, therefore, provides a valve that allows to regulate the air-inlet flow into the bottle, indirectly regulating the liquid outlet flow drunk by the infant.

### BRIEF DESCRIPTION OF THE DRAWINGS

FIG. 1 shows a view in perspective from above of the valve

FIG. 2 is a view in perspective from below of the same valve.

FIG. 3 shows a view in perspective from above of the valve inserted in the bottles threaded base.

FIG. 4 is a cross-section of the valve in a closed position thereof, with the threaded base of the bottle completely closed.

FIG. 5 shows another cross-section of the valve but in an open position, with the base of the bottler slightly unthreaded.

FIG. 6 shows a view in perspective from above of the threaded base without the valve or membrane included.

FIG. 7 is a view in perspective from below of the same threaded base of FIG. 6, showing the air-inlet openings.

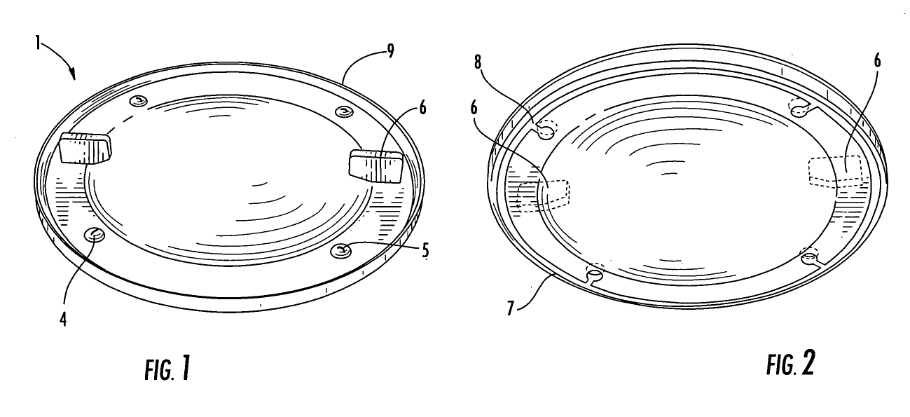

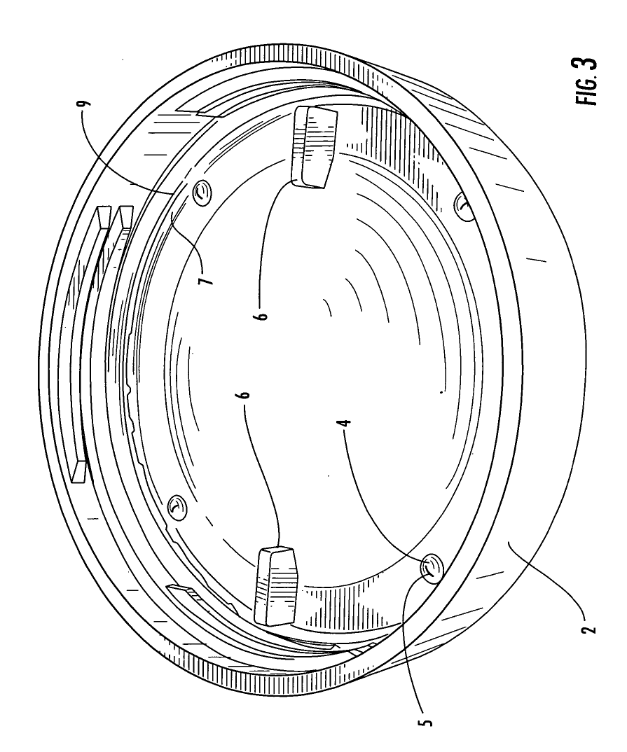

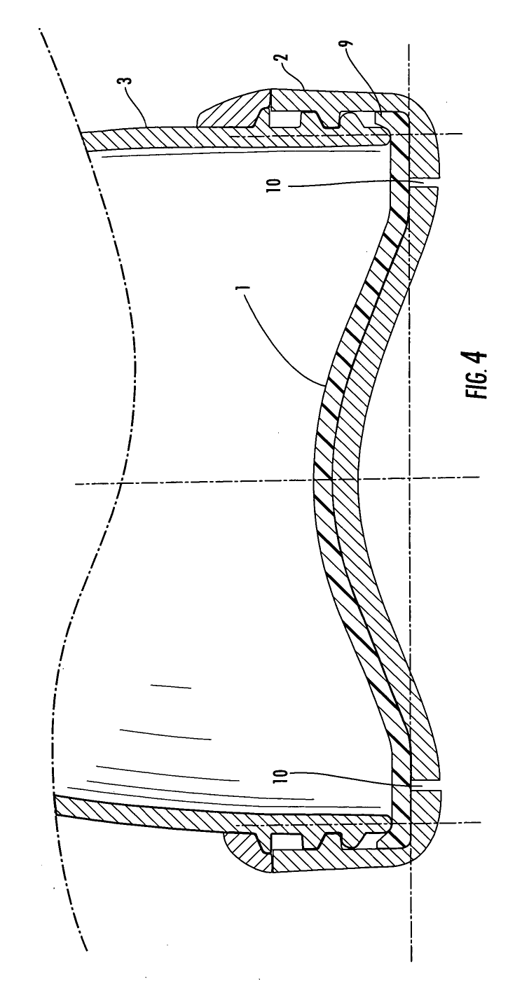

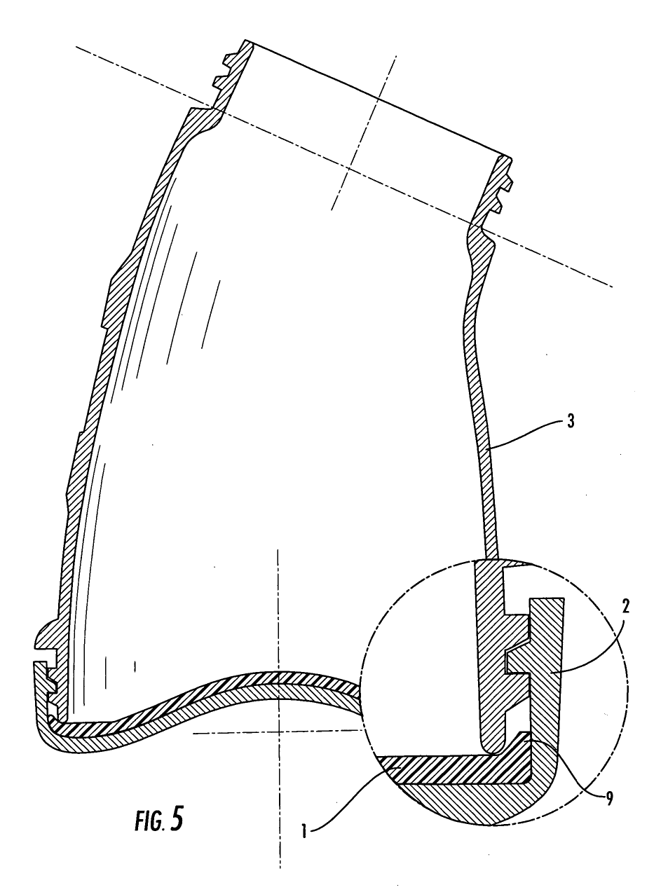

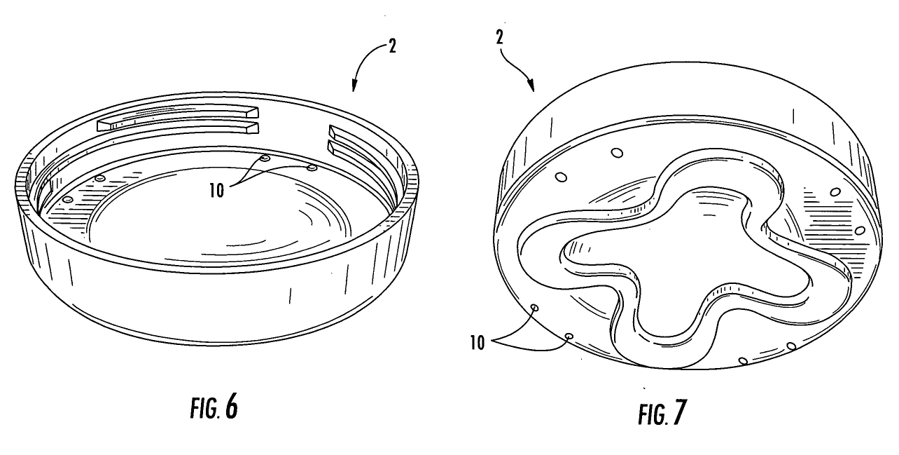

### DETAILED DESCRIPTION OF THE INVENTION

Proposed valve (1) comprises a slightly concave circular membrane placed on the inside of the threaded base (2) of the nursing bottles (3) body and comprises small domes (4) on the inner or upper side (where the liquid is). Said domes (4) have a slit (5) at the end, through which air flows when there is an unbalance of pressure in the bottle.

The novel component claimed in the present invention are the vent channels (6) in the valve (1) membrane on the outer side (facing the domes, where there is no liquid). This outer or lower side of the membranes is the one contacting the threaded base (2) of the bottle. Preferably there are two of said vent channels (6), being slender and which height is similar to the total height of the membrane.

The circular membrane comprises a perimeter wall or edge (9) that fits on the inner perimeter of the threaded base (2), continuing with a hollow perimeter channel (7) allowing air to circulate when the base (2) is unthreaded. The domes (4) are connected to the perimeter channel (7) by small bridges (8) that complete air-inlet flow, that will be regulated according to how much the vent channels (6) have been squashed, which are also connected to the hollow perimeter channel (7).

These vent channels (6) allow air to flow from outside the nursing bottle towards the domes, through a series of openings (10) in the bottles threaded base (2), these openings being the air-inlet for atmospheric air. This series of openings (10) are located in the perimeter of the threaded base, coinciding with the valve (1) membrane hollow perimeter channel (7). Such that air enters the bottle from the outside, balancing the pressure that has been unbalanced by the infants suction.

As the valve (1) membrane is made of silicone or any other elastomers, it is resilient and can be squashed or deformed, such that who is feeding the child or baby, can regulate the liquid flow that the baby drinks by partially threading or unthreading the base (2) of the nursing bottle (3). When said base (2) is threaded, the valve (1) is squashed against the edge of the bottle (FIG. 4), this pressure causes the vent channels (6) to begin to collapse, partially or totally limiting the air flow into the nursing bottle (3).

As more force is applied on the threading (2), the air flow is further closed leading to total closure, where the valve (1) no longer works as such, as no air enters the bottle.

Complete closure is produced when the vent channels (6) have completely collapsed; therefore, air has no way of entering the nursing bottle.

Then, if the base (2) is unthreaded a bit, the vent channels (6) begin to recover their shape and allow air into the bottle. As air enters, the pressure is balanced in the bottle and the outward liquid flow increases, in this manner it is possible to regulate the liquid flow that the baby drinks.

This proposed embodiment of regulating valve with deformable vent channels, aids in avoiding that the baby drink liquid too fast as with traditional valves, favouring a better digestion.

Another advantage that the proposed valve has compared to the known prior art, refers to the way of heating the liquid in the nursing bottle. The use of the microwave oven to heat food to be ingested by a baby, including a nursing bottle with milk, is known to be rejected by part of society; for which reason bottles are heated in a double boiler, i.e., place the bottle in a jug of boiling water on the flame.

The proposed valve that allows to regulate inlet of air to the bottle, is fit to be heated in the manner described without running the risk that the content of the bottle gets mixed with boiling water; as it will be sufficient to completely close the threaded base (2) of the bottle to achieve desired airtightness, whist known bottle models with air vents are always open, running the risk that hot water will flow through the air-inlets and mix with the content of the nursing bottle.

When putting the described nursing bottles air-inlet regulating valve into practice, modifications and/or variations could be introduced, all of which would be considered to be comprises within the scope of the present invention; said scope being determined basically, by the text of the claims below.

We claim:

1. Nursing bottle air-inlet regulating valve comprising an elastomeric resilient membrane with hollow domes having a slit and a threaded base with air-inlet openings, wherein the membrane comprises a perimeter edge that fits in the inner perimeter of said threaded base of the nursing bottle and continuing with a hollow perimeter channel communicating with the vent channels in the membrane on its underside, that contacts the threaded base of the nursing bottle.

2. Nursing bottle air-inlet regulating valve according to claim 1, wherein said vent channels are deformable.

3. Nursing bottle air-inlet regulating valve according to claim 1, wherein the domes are connected to the perimeter channel through small bridges that complete the air-inlet inlet flow.

4. Nursing bottle air-inlet regulating valve according to claim 1, wherein there are at least two air-inlet openings in the threaded base.
